(19) United States
(12) Patent Application Publication
(10) Pub. No.: US 2024/0424926 A1
(43) Pub. Date: Dec. 26, 2024

(54) CHARGING STATION, ESPECIALLY FOR ELECTRIC VEHICLES, PLUG ADAPTER FOR USE WITH SUCH A CHARGING STATION AND METHOD TO OPERATE A CHARGING STATION

(71) Applicant: ads-tec Energy GmbH, Nürtingen (DE)

(72) Inventor: Thomas SPEIDEL, Markgröningen (DE)

(21) Appl. No.: 18/746,217

(22) Filed: Jun. 18, 2024

(30) Foreign Application Priority Data
Jun. 26, 2023 (DE) 102023116779.0

(51) Int. Cl. B60L 53/16; H01R 13/639; H01R 31/06; H02J 7/00

(52) U.S. Cl. CPC B60L 53/16; H02J 7/0042; H01R 13/6397; H01R 31/06

(57) ABSTRACT

The invention relates to a charging station (1), in particular for electric vehicles, having at least one charging point (5) comprising a charging plug (7) for electrical connection to an electrical device to be charged, and having at least one adapter receptacle (9) which is adapted to receive a plug adapter (3) for use with the charging plug (7), wherein the adapter receptacle (9) is adapted to alternately adopt a plurality of modes, wherein the adapter receptacle (9) is adapted to hold the plug adapter (3) secured against unauthorized removal in a locking mode of the plurality of states and to release the plug adapter (3) for removal in an unlocking mode of the plurality of states, wherein the charging station (1) further comprises a control device (11) which is operatively connected to the adapter receptacle (9) and adapted to monitor a current mode of the adapter receptacle (9).

The invention relates to a charging station, in particular for electric vehicles, a plug adapter for use with such a charging station and a method for operating a charging station.

Various standards of plugs and sockets have become established in different regions for charging electrical devices, in particular electric vehicles at charging stations. In particular, there are standards that only allow comparatively slow charging using alternating current, and combination standards in which the charging option using alternating current and also a comparatively faster charging option using direct current are provided in a common plug. In addition, fast charging stations typically use the contact pattern of the AC plug to exchange information with a charging device, while the DC contacts are used for fast charging. Such combination standards can thus comprise separate contact systems for direct current on the one hand and alternating current on the other, such as CCS1 or CCS2, or they can use an identical contact system for direct current and alternating current, such as NACS. The problem is that a certain type of plug is typically permanently installed at a conventional charging station, in particular at a fast charging station, so that electrical devices such as electric vehicles that do not comprise a charging socket that matches this type of plug cannot be charged. In principle, plug adapters have also become known with which one type of plug can be adapted to another type of socket, but such plug adapters have to be carried around by the user of the electrical charging device, for example in an electric vehicle, which is cumbersome. While it would in principle be possible to store such plug adapters at a charging station, this raises consequential problems, in particular with regard to unintentional removal or even theft by users of the charging station.

The invention is therefore based on the task of creating a charging station, in particular for electric vehicles, a plug adapter for use with such a charging station and a method for operating a charging station, wherein the disadvantages mentioned are at least reduced, preferably do not occur.

The task is solved by providing the present technical teaching, in particular the teaching of the independent claims and the embodiments disclosed in the dependent claims and the description.

In particular, the task is solved by providing a charging station, in particular for electric vehicles, comprising at least one charging point comprising at least one charging plug for electrical connection to an electrical device to be charged, in particular an electric vehicle. The charging station also comprises at least one adapter receptacle which is adapted to receive a plug adapter adapted to be used with the charging plug, wherein the adapter receptacle is adapted to alternately adopt a plurality of modes. The adapter receptacle is adapted to hold the plug adapter secured against unauthorized removal in a locking mode of the plurality of modes and to release the plug adapter for removal in an unlocking mode of the plurality of modes. The charging station—or a unit externally assigned to the charging station—also comprises a control device that is operatively connected to the adapter receptacle and adapted to monitor a current mode of the adapter receptacle. Advantageously, in this way at least one plug adapter can be stored directly in the area of the charging station, in particular at the charging station, so that a user of an electrical device to be charged no longer needs to carry such a plug adapter with them. By keeping the plug adapter secured against unauthorized removal in the locking mode of the adapter receptacle, arbitrary removal of the secured plug adapter is effectively prevented. As the control device can monitor the current mode of the adapter receptacle, it is also possible to prevent accidental or arbitrary removal of the plug adapter used for charging and, additionally or alternatively, to initiate measures if the plug adapter is stolen or accidentally taken. This in turn makes the provision of the plug adapter on the charging station appear sensible and economical from the operator's point of view.

The fact that the charging station comprises the control device means that the control device is assigned to the charging station in such a way that the functionality of the control device can be implemented in or by the charging station. The control device itself can be arranged inside or outside a housing of the charging station, even remotely, for example in a backend or a cloud, or can also be implemented virtually. It is also possible for the functionality of the control device to be implemented partly inside the housing of the charging station and partly outside the housing, wherein in particular different computing devices can work together to implement the functionality of the control device. In particular, the control device is thus assigned to the charging station.

In an embodiment, the control device is adapted to monitor, as the current mode of the adapter receptacle, in particular whether the adapter receptacle is arranged in the locking mode or in the unlocking mode. In this way, it can be determined directly whether the plug adapter is received by the adapter receptacle and also locked.

Alternatively or additionally, the control device is adapted to monitor, as the current mode of the adapter receptacle, whether the plug adapter is received by the adapter receptacle, in particular by means of a suitable sensor apparatus described below. In this way, it can be determined more generally whether the plug adapter has been put back—regardless of the locking mode. However, in a preferred embodiment, it is provided that the adapter receptacle automatically enters the locking mode as soon as the plug adapter is received by the adapter receptacle.

In an embodiment, the adapter receptacle is configured as a plug socket with a locking device, in particular analogous to corresponding charging sockets known from electric vehicles, which also provide a locking device for the charging plug. The adapter receptacle can be geometrically matched to the charging plug, in particular without comprising corresponding electrical contacts. In this respect, the adapter receptacle then only serves to geometrically hold and thus store the plug adapter. In this case, the mode of the adapter receptacle is in particular a mode of the locking device of the charging socket.

It is possible that the charging station additionally comprises a rain or moisture protection for the plug adapter arranged in the adapter receptacle, for example a kind of rain roof over the adapter receptacle.

In another embodiment, the adapter receptacle is configured as a storage compartment or storage space with lockable access, in particular with a lockable door. In this case, the plug adapter is stored—in particular within the charging station—in a protected or access-restricted area, in particular a type of safe. In this case, the mode of the adapter receptacle is in particular one of lockable access, in particular the lockable door.

In an embodiment, the charging station comprises a plurality of adapter receptacles for a plurality of charging plugs—in particular one charging plug per adapter receptacle. In particular, the charging station in this case comprises a plurality of adapter receptacles for a plurality of different charging plugs, i.e. in particular charging plugs with different pairs of plug connection types—plug side and socket side. Advantageously, more than two different electrical devices, in particular more than two different electric vehicles, with more than two different charging sockets can be charged at the charging station in this way.

In an embodiment, the charging station comprises an associated adapter receptacle—and optionally an associated plug adapter—for each charging point. In an embodiment, the charging station comprises a plurality of associated adapter receptacles for each charging point, as well as optionally a plurality of associated plug adapters, in particular with different pairs of plug connection types—plug side and socket side.

In electrical engineering, a charging station is any charging device or electrical system, in particular stationary or mobile, which is used to supply energy to mobile battery-powered electrical devices, appliances, machines or motor vehicles by simply plugging them in without having to remove the traction energy storage device—such as the traction battery of an electric car. Charging stations for electric cars are sometimes also referred to as “charging stations” and can comprise several charging points. High performance charging systems (HPC systems) such as the combined charging system (CCS), which is widely used in Europe, are known in particular. With generic direct current charging, direct current from the charging station is fed directly into the vehicle's battery and supplied by a powerful rectifier, preferably from the charging station, from the power grid or from large buffer accumulators at solar charging stations, for example. There is a battery management system in the vehicle that communicates directly or indirectly with the charging station in order to adjust the current and voltage or to terminate the process when a predetermined capacity limit is reached. Power electronics are usually located in the charging station. As the direct current connections of the charging station are connected directly to the corresponding connections of the traction battery—without going via an AC/DC converter of the vehicle—high charging currents can be transmitted with low losses, which enables short charging times.

In an embodiment, the charging station is configured as a charging pole. In particular, the charging station comprises at least one charging point, in particular exactly one charging point or exactly two charging points.

In particular, the charging station is configured as a fast charging station. In an embodiment, the charging station is configured as a battery-supported charging station, in particular as a battery-supported fast charging station.

According to a further development of the invention, it is provided that the control device is adapted to control loading procedures of the charging station and to complete an active loading procedure only when the adapter receptacle is in the locking mode. Advantageously, in this way, a user is prevented from terminating the loading procedures and moving away as long as the plug adapter is not arranged in the adapter receptacle again.

Alternatively or additionally, the control device is adapted to complete the active loading procedure by noting the unlocking mode in a dataset associated with the active loading procedure if the adapter receptacle is not in the locking mode. Advantageously, this provides a way of dealing with cases in which the plug adapter is not arranged back in the adapter receptacle.

In an embodiment, the control device is adapted to note the unlocking mode in the dataset by setting a note, for example a flag, in the dataset, wherein the control device optionally—in particular simultaneously—notifies the police or another authority or automatically files a report, or initiates such an action, possibly via a backend or a cloud. Alternatively or additionally, the control device is adapted to assign a penalty fee to the active loading procedure, in particular to charge the user a correspondingly increased fee, and in this way to note the unlocking mode in the dataset. Instead of a penalty fee, the costs or the monetary value of the plug adapter itself can also be charged additionally.

In an advantageous embodiment, this is communicated to the user—in particular visually or acoustically, in particular via the output of a warning message on a display of the charging station—wherein the user is optionally simultaneously given the opportunity to return the plug adapter to the adapter receptacle in order to avoid the negative consequences for him.

According to a further development of the invention, it is provided that the control device is adapted to set the adapter receptacle to the unlocking mode. Advantageously, in this way the adapter receptacle can be actively released by the control device, in particular if at least one predetermined condition is fulfilled, for example if a loading procedure has previously been successfully initiated or identified.

In an embodiment of the charging station, the adapter receptacle is adapted to automatically or automatically move from the unlocking mode to the locking mode when the plug adapter is received again by the adapter receptacle. This automatic locking can be purely mechanical, for example by means of spring preload of a locking mechanism, or electrical, in particular by means of an actuator or electromagnet controlled or triggered by the plug adapter.

In another embodiment of the charging station, the control device is adapted to set the adapter receptacle to the locking mode, in particular when the plug adapter is received again by the adapter receptacle. In an embodiment, the control device is operatively connected to a sensor device for this purpose, which is adapted to determine that the plug adapter is received by the adapter receptacle. The sensor device can be configured purely mechanically, in particular as a type of button, or it can comprise a light measurement, for example a light barrier. It is also possible for the sensor device to comprise a photocell or a camera, wherein changes in an exposure situation, brightness or an image of the plug adapter arranged in the adapter receptacle can be detected.

However, the sensor device can also be configured electrically or electromagnetically and function, for example, via an electrical contact or a change in capacitance or the like.

In an embodiment, the control device is adapted to set the adapter receptacle to the unlocking mode only after initialization, in particular only after identification of a loading procedure. Advantageously, the plug adapter can only be released for removal once a loading procedure has actually been initialized and, in particular, identified in an assignable manner. It is then also possible, if necessary, to assign a removal of the plug adapter and to initiate corresponding measures in a targeted manner.

According to a further development of the invention, it is provided that the control device is adapted to uniquely identify a charging procedure of the charging station and to assign a removal procedure of the plug adapter to an identified charging procedure when the adapter receptacle is set to the unlocking mode after the identification of the charging procedure. In particular, this makes it possible to assign the removal of the plug adapter to a specific loading procedure and at the same time to a specific user and to initiate appropriate measures in the event that the plug adapter is removed.

In an embodiment, the control device is adapted to uniquely identify a user of the charging station and to assign the removal process to the identified user. The identification of the user also represents an identification of the loading procedure by the user, so that the removal procedure is also assigned to the loading procedure at the same time as the removal procedure is assigned to the user. In particular, the user can be identified by means of a so-called charging card, which typically comprises an RFID chip with a specific identifier, via an app, via communication between the charging station and the charging device, for example Plug & Charge, or in another suitable manner. This also identifies the loading procedure.

According to a further development of the invention, it is provided that the adapter receptacle is adapted to determine whether the plug adapter is received by the adapter receptacle, and to only then—and optionally always then-move from the unlocking mode to the locking mode if—in particular as soon as—the plug adapter is received by the adapter receptacle. In an embodiment, the sensor device described above, which is optionally operatively connected to the control device, is assigned to the adapter receptacle for this purpose. Advantageously, the adapter receptacle is arranged in an unambiguous mode depending on the arrangement of the plug adapter in or on the adapter receptacle, namely precisely when and only when the plug adapter is not received by the adapter receptacle and precisely when and only when the plug adapter is received by the adapter receptacle.

According to a further development of the invention, it is provided that the charging station, in particular the control device, is adapted to move a plug locking of a plug adapter from a lock position to a release position when the adapter receptacle is in the locking mode. With the plug locking device, the plug adapter can be advantageously locked to the charging plug of the charging station so that it is firmly connected to the charging station even in this situation and cannot be removed.

In an embodiment, the control device is adapted to set the adapter receptacle to the unlocking mode only when the plug locking of the plug adapter is in its lock position. A user must then first insert the charging plug into the plug adapter, which moves the plug locking into the lock position and thus locks it, before the plug adapter is released by the adapter receptacle and can be removed from it. The plug adapter is then firmly connected to the charging plug and, in particular, locked to it. Only when the plug adapter is received again by the adapter receptacle and is arranged in its locking mode in particular, the plug locking is also moved back into its release position and the charging plug can be removed from the plug adapter. In this case, however, the plug adapter is then firmly connected to the adapter receptacle again. Thus, in this embodiment, there is no mode in which the plug adapter would not be firmly connected to the charging station and could be removed.

The charging station, in particular the control device, can be adapted to actively—in particular by means of a suitable signal or an electrical or electromagnetic pulse—or passively—in particular by means of a mechanical or magnetic active connection—move the plug locking of the plug adapter from the lock position to the release position.

In an embodiment, the plug locking is adapted to automatically move from the release position to the lock position when the charging plug is inserted into the plug adapter, for example by means of a preloaded latching element or the like.

According to a further development of the invention, it is provided that the charging station comprises a plug adapter, in particular a plug adapter according to the invention or a plug adapter according to one or more of the embodiments described below.

In particular, the plug adapter is received in the adapter receptacle, in particular in a locking or interlocking manner.

In an embodiment, the charging station comprises a plurality of plug adapters, in particular a plurality of different plug adapters, each with a different pairing of plug connection types—plug side and socket side.

In an embodiment, each plug adapter is assigned a separate adapter receptacle. In particular, the individual adapter receptacles are each designed and optionally operatively connected to the control device as described above in connection with the adapter receptacle. In particular, this applies to each of the adapter receptacles. In particular, the control device is adapted to monitor the plurality of adapter receptacles, in particular each adapter receptacle, with regard to its current mode.

The task is also solved by providing a plug adapter for use with a charging station according to the invention or a charging station according to one or more of the embodiments described above, wherein the plug adapter comprises a socket part and a plug part, wherein the socket part is adapted to cooperate with the charging plug of the charging station, wherein the plug part is adapted to cooperate with a charging socket of an electrical device to be charged. In particular, the advantages already described in connection with the charging station arise in connection with the plug adapter.

In an embodiment, the socket part comprises a plug locking device which is adapted to lock the charging plug of the charging station to the plug adapter in a lock position when the charging plug is inserted into the socket part, and to release the charging plug in a release position. In particular, the plug locking is designed and functions in the same way as already described above in connection with the charging station.

In particular, the plug locking automatically moves from the release position to the lock position when the charging plug is inserted into the plug adapter. Alternatively or additionally, the plug locking is moved by the charging station, in particular by the control device—actively or passively—from the lock position to the release position.

According to a further development of the invention, it is provided that the socket part comprises a plug connection type selected from a group consisting of: CCS1, CCS2, Type 1 or J1772, GB/T, Type 2 or Mennekes, CHAdeMO, and NACS; wherein the plug part comprises another connector type selected from the same group consisting of: CCS1, CCS2, Type 1 or J1772, GB/T, Type 2 or Mennekes, CHAdeMO, and NACS.

In an embodiment, the socket part comprises the connector type CCS1 and the plug part comprises the connector type NACS. In another embodiment, the socket part comprises the plug connection type NACS and the plug part comprises the plug connection type CCS1. In another embodiment, the socket part comprises the plug connection type CCS2 and the plug part comprises the plug connection type NACS. In another embodiment, the socket part comprises the plug connection type NACS and the plug part comprises the plug connection type CCS2. In further embodiments, all conceivable combinations of existing or future connector types are possible.

The task is also solved by creating a method of operating a charging station, in particular for charging an electrical device at the charging station, wherein a current mode of an adapter receptacle is monitored. In particular, the advantages already explained in connection with the charging station or the plug adapter arise in connection with the method.

In particular, in the method, a charging station according to the invention or a charging station according to one or more of the embodiments described above is operated.

According to a further development of the invention, it is provided that the method comprises the following steps: a) Initializing and/or identifying a loading procedure; optionally b) Checking whether a plug adapter request is present; optionally c) Charging the electrical device to be charged; d) Checking whether the adapter receptacle is locked, and e) Completing the loading procedure if the adapter receptacle is locked.

A plug adapter request can be present in particular by inserting the charging plug into the plug adapter. Advantageously, the charging station comprises a suitable test mechanism with which this can be determined. Thus, in an embodiment, step b) checks whether the charging plug is inserted into the plug adapter.

In particular, the adapter receptacle is unlocked—in a step b1) after the step b) and before the step c) or d)—, i.e. set in its unlocking mode, if a plug adapter request is present.

Optionally—in a step b2) after step b1) and before step c) or d)—the plug adapter is removed.

Optionally—in a step d0) before step d), in particular after step c)—the plug adapter is arranged in the area of the adapter receptacle, in particular in or on the adapter receptacle. Further optionally—in a step d01) after the step d0) and before the step d)—the adapter receptacle is set to the locking mode.

According to a further development of the invention, it is provided that the loading procedures—in a step f)—is not completed if the adapter receptacle is not locked.

Alternatively or additionally, it is provided that the loading procedure is completed by recording a note in a dataset associated with the loading procedure if the adapter receptacle is not locked.

In an embodiment, a plug adapter according to the invention or a plug adapter according to one or more of the embodiments described above is used in the method.

Optionally, the plug adapter is—in a step b0) before step d), in particular before step c), in particular before step b1) locked to the charging plug by moving the plug locking to the lock position.

Optionally—in a step d1) before step e), in particular after step d)—the plug adapter releases the charging plug by displacing the plug locking into the release position when it is determined in step d) that the adapter receptacle is locked.

The invention is explained in more detail below with reference to the drawing. Thereby shows:

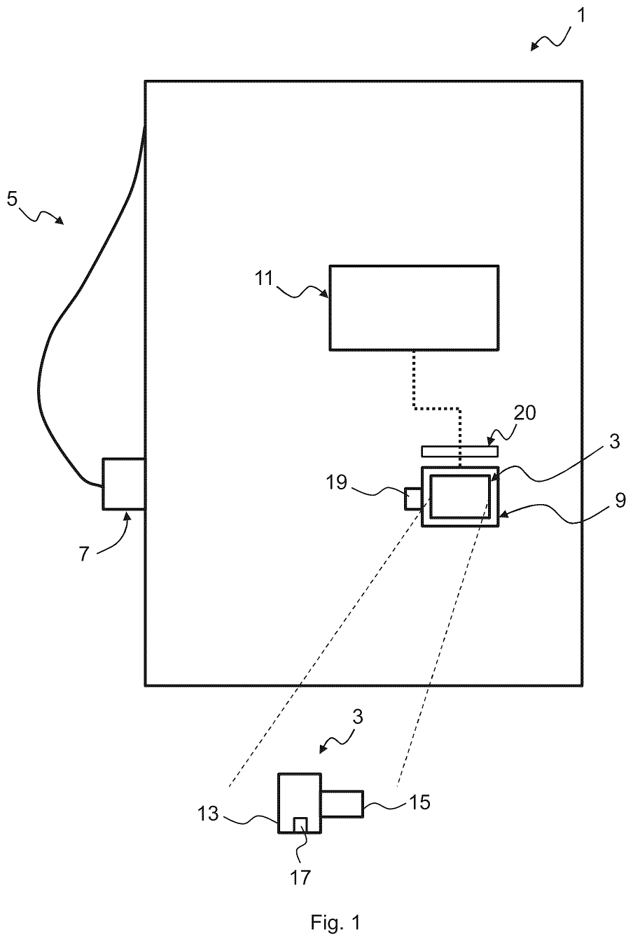

FIG. 1 a schematic representation of an embodiment example of a charging station with a plug adapter, and

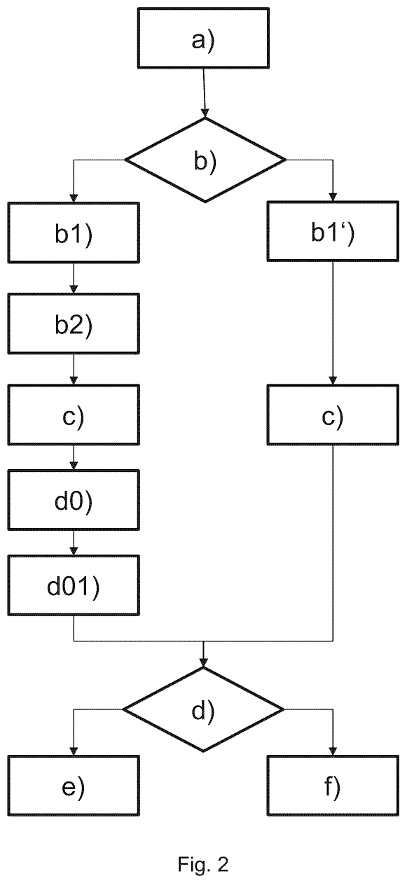

FIG. 2 a schematic representation of an embodiment example of a method for charging an electrical device at the charging station.

FIG. 1 shows a schematic representation of an embodiment example of a charging station 1 with a plug adapter 3.

The charging station 1, which is in particular adapted to charge a traction energy storage unit of an electric vehicle, comprises at least one charging point 5 with a charging plug 7 for electrical connection to an electrical device to be charged—in particular to the electric vehicle. In addition, the charging station 1 comprises at least one adapter receptacle 9, which is adapted to receive the plug adapter 3 for use with the charging plug 7. The adapter receptacle 9 is adapted to alternately adopt a plurality of modes, specifically to hold the plug adapter 3 secured against unauthorized removal in a locking mode of the plurality of modes and to release the plug adapter 7 for removal in an unlocking mode of the plurality of modes. The charging station 1 also comprises a control device 11, which is operatively connected to the adapter receptacle 9 and adapted to monitor a current mode of the adapter receptacle 9.

The charging station 1 can comprise a plurality of charging points 5 and/or a plurality of adapter receptacles 9.

In particular, the charging station 1 comprises at least one plug adapter 3, in particular one plug adapter 3 for each adapter receptacle 9, preferably at least one adapter receptacle 9 with a plug adapter 3 for each charging point 5.

The plug adapter 3 comprises a socket part 13 and a plug part 15. The socket part 13 is adapted to interact with the charging plug 7. The plug part 15 is adapted to interact with a charging socket of the electrical device to be charged, in particular of the electric vehicle.

Preferably, the socket part 13 comprises a plug locking 17 which is adapted to lock the charging plug 7 to the plug adapter 3 in a lock position when the charging plug 7 is inserted into the socket part 13 and to release the charging plug 7 in a release position.

The adapter receptacle 9 preferably comprises a locking device 19. In particular, the control device 11 is operatively connected to the locking device 19.

Preferred, the charging station 1 additionally comprises a rain or moisture protection for the plug adapter 3 arranged in the adapter receptacle 9, in particular a rain cover 20 over the adapter receptacle 9.

Preferred, the socket part 13 comprises a plug connection type selected from a group consisting of: CCS1, CCS2, type 1 or J1772, GB/T, type 2 or Mennekes, CHAdeMO, and NACS. The plug part 15 comprises another plug connection type selected from the same group.

The control device 11 is preferably adapted to control loading procedures of the charging station 1, and to complete an active loading procedure only when the adapter receptacle 9 is in the locking mode, or to complete the active loading procedure by noting the unlocking mode in a dataset associated with the active loading procedure when the adapter receptacle 9 is not in the locking mode.

The control device 11 is also preferably adapted to set the adapter receptacle 9 to the unlocking mode, in particular only after initialization—in particular identification—of a loading procedure.

Furthermore, the control device 11 is preferably adapted to uniquely identify a charging procedure of the charging station 1, in particular a user, and to assign a removal procedure of the plug adapter 3 to an identified charging procedure when the adapter receptacle 9 is set to the unlocking mode after the identification of the charging procedure.

The adapter receptacle 9 is preferably adapted to determine whether the plug adapter 3 is received by the adapter receptacle 9, and to move from the unlocking mode to the locking mode only if the plug adapter 3 is received by the adapter receptacle 9.

The charging station 1, in particular the control device 11, is preferably adapted to move the plug locking 17 of the plug adapter 3 from the lock position to the release position when the adapter receptacle 9 is in the locking mode.

FIG. 2 shows a schematic representation of an embodiment example of a method for charging an electrical device at the charging station 1.

Identical and functionally identical elements are provided with the same reference symbols in all figures, so that reference is made to the previous description in each case.

In a first step a), a loading procedure is initialized and identified. In a second step b), it is checked whether a plug adapter request is present, preferably by checking whether the charging plug 7 is plugged into the plug adapter 3.

In a third step b1), the adapter receptacle 9 is unlocked if a plug adapter request is present, in particular if the charging plug 7 is plugged into the plug adapter 3. Otherwise, the adapter receptacle 9 remains locked in a fourth step b1′).

If the adapter receptacle 9 is unlocked, the plug adapter 3 is removed in a fifth step b2), and the charging device to be charged is charged in a sixth step c). Otherwise—without a plug adapter requirement—the electrical device to be charged is charged in step c) without the plug adapter 3.

If the plug adapter 3 is used, it is arranged again in the area of the adapter receptacle 9 in a sixth step d0)—after charging—and the adapter receptacle 9 is put back into locking mode in a seventh step d01).

In an eighth step d), it is checked whether the adapter receptacle 9 is locked, and in a ninth step e), the loading procedures is completed if the adapter receptacle 9 is locked. Alternatively, the loading procedure is not completed in a tenth step f) if the adapter receptacle 9 is not locked, or the loading procedure is completed in the tenth step f) by recording a note in a dataset associated with the loading procedure if the adapter receptacle 9 is not locked. Optionally, in the tenth step f), the control device 11 automatically takes or initiates additional measures, possibly via a backend or a cloud, such as sending information to the police or another authority, automatically filing a complaint, or charging a penalty fee or costs for the plug adapter 3.

Optionally, the plug adapter 3 is locked to the charging plug 7 before step b1) by moving the plug locking 17 to the lock position. Only then is the adapter receptacle 9 unlocked.

Optionally, the plug adapter 3 releases the charging plug 7 after step d) by moving the plug locking 17 to the release position if it is determined in step d) that the adapter receptacle 9 is locked.

1. Charging station (1), in particular for electric vehicles, having at least one charging point (5) comprising a charging plug (7) for electrical connection to an electrical device to be charged, and having at least one adapter receptacle (9) which is adapted to receive a plug adapter (3) for use with the charging plug (7), wherein the adapter receptacle (9) is adapted to alternately adopt a plurality of modes, wherein the adapter receptacle (9) is adapted to hold the plug adapter (3) secured against unauthorized removal in a locking mode of the plurality of states and to release the plug adapter (3) for removal in an unlocking mode of the plurality of states, wherein the charging station (1) further comprises a control device (11) which is operatively connected to the adapter receptacle (9) and adapted to monitor a current mode of the adapter receptacle (9).

2. Charging station (1) according to claim 1, wherein the control device (11) is adapted to control loading procedures of the charging station (1), and to complete an active loading procedure only when the adapter receptacle (9) is in the locking mode, or to complete the active loading procedure by noting the unlocking mode in a dataset associated with the active loading procedure when the adapter receptacle (9) is not in the locking mode.

3. Charging station (1) according to one of the preceeding claims, wherein the control device (11) is adapted to set the adapter receptacle (9) to the unlocking mode, in particular only after initialization—in particular identification—of a loading procedure.

4. Charging station (1) according to one of the preceding claims, wherein the control device (11) is adapted to uniquely identify a charging operation of the charging station (1), in particular a user, and to assign a removal operation of the removal of the plug adapter (3) to an identified charging operation, if the adapter receptacle (9) is set to the unlocking mode after the identification of the charging operation.

5. Charging station (1) according to one of the preceeding claims, wherein the adapter receptacle (9) is adapted to determine whether the plug adapter (3) is received by the adapter receptacle (9), and to move from the unlocking mode to the locking mode only when the plug adapter (3) is received by the adapter receptacle (9).

6. Charging station (1) according to one of the preceeding claims, wherein the charging station (1) is adapted to move a plug locking of a plug adapter (3) from a lock position to a release position when the adapter receptacle (9) is in the locking mode.

7. Charging station (1) according to one of the preceeding claims, wherein the charging station (1) comprises a plug adapter (3), in particular a plug adapter (3) according to one of the claim 8 or 9.

8. Plug adapter (3) for use with a charging station (1) according to one of the claims 1 to 7, wherein the plug adapter (3) comprises a socket part (13) and a plug part (15), wherein the socket part (13) is adapted to cooperate with the charging plug (7) of the charging station (1), wherein the plug part (15) is adapted to cooperate with a charging socket of a charging station (1) to be charged, to cooperate with a charging socket of an electrical apparatus to be charged, wherein optionally the socket part (13) comprises a plug locking device (17) which is adapted to lock the charging plug (7) of the charging station (1) to the plug adapter (3) in a lock position when the charging plug (7) is inserted into the socket part (13), and to release the charging plug (7) in a release position.

9. Plug adapter (3) according to claim 8, wherein the socket part (13) comprises a plug connection type selected from a group consisting of: CCS1, CCS2, Type 1 or J1772, GB/T, Type 2 or Mennekes, CHAdeMO, and NACS, and wherein the plug part (15) comprises another plug connection type selected from the same group.

10. Method for operating a charging station (1), in particular for electric vehicles, wherein a current mode of an adapter receptacle (9) is monitored.

11. Method according to claim 10, wherein the following steps are performed:
Initializing and/or identifying a loading procedure;
Optionally charging the electrical device to be charged;
Checking whether the adapter receptacle (9) is locked, and
Completing the loading procedure when the adapter receptacle (9) is locked.

12. Method according to claim 11, wherein the loading procedure is not completed or is completed with the inclusion of a note in a dataset associated with the loading procedure if the adapter receptacle (9) is not locked.
